(19) United States
(12) Patent Application Publication
(10) Pub. No.: US 2013/0310237 A1
(43) Pub. Date: Nov. 21, 2013

(54) DIE REPLACING METHOD FOR PRESS FORMING MACHINE

(71) Applicants: Yoichiro Kojima, Toyota-shi (JP); Masanori Ogawa, Toyota-shi (JP); Masaaki Ando, Toyota-shi (JP); Akira Sakakibara, Toyota-shi (JP)

(72) Inventors: Yoichiro Kojima, Toyota-shi (JP); Masanori Ogawa, Toyota-shi (JP); Masaaki Ando, Toyota-shi (JP); Akira Sakakibara, Toyota-shi (JP)

(73) Assignees: TEKUNOHAMA CO., LTD, Toyota-shi, Aichi (JP); KOJIMA PRESS INDUSTRY CO., LTD., Toyota-shi, Aichi (JP)

(21) Appl. No.: 13/990,687

(22) PCT Filed: Nov. 30, 2010
(86) PCT No.: PCT/JP2010/071388

§ 371 Date: Aug. 8, 2013

(51) Int. Cl. B23Q 3/155

(52) U.S. Cl. CPC B23Q 3/15573
USPC 483/28

(57) ABSTRACT

In a press forming machine, a material inserted between at least one pair of oppositely positioned dies can be pressed by the at least one pair of dies, so that a work can be formed from the material. When the at least one pair of dies is replaced, the at least one pair of dies can be replaced while the material or the work is held between the at least one pair of dies.

### TECHNICAL FIELD

The present invention relates to a die replacing method for a press forming machine. More particularly, the present invention relates to a die replacing method for a press forming machine in which a material inserted between two oppositely positioned dies can be pressed by these two dies, so that a work can be formed from the material.

### BACKGROUND ART

A press forming machine has already been known. In the press forming machine, a material inserted between two oppositely positioned dies can be pressed by these two dies, so that a work can be formed from the material. In such a press forming machine, a die replacing method for replacing the two dies is known. In the known die replacing method, when the two dies are replaced, the two dies are replaced after the work is removed from between these two dies. An example of such a press forming machine is a vertical three-tiered press machine taught by Patent Document 1.

### PRIOR ART DOCUMENTS

### Patent Documents

Patent Document 1: Japanese Laid-Open Patent Publication No. 2000-015496.

### SUMMARY OF THE INVENTION

### Problems to be Solved by the Invention

However, in the above-mentioned conventional technique, the two dies has been replaced while the work is removed from between the two dies. This may lead to an increased number of die replacement steps to replace the dies. In particular, in the vertical three-tiered press machine as described in Patent Document 1, processing operations of materials can be performed in succession. Therefore, press working has to be repeated until all of the processing operations (the processing operation in a final step) to be successively performed on a final material have been completed. Thus, the press machine must be operated in order to remove the material from the dies. This may lead to a further increased number of die replacement steps.

The present invention is intended to solve the above-mentioned problems. It is an object of the present invention to provide a replacing method that can reduce as much as possible the number of die replacement steps in a press forming machine.

### Means for Solving the Problems

The present invention may provide a die replacing method for a press forming machine in which a material inserted between at least one pair of oppositely positioned dies can be pressed by the at least one pair of dies, so that a work can be formed from the material, wherein when the at least one pair of dies is replaced, the at least one pair of dies can be replaced while the material or the work are held between the at least one pair of dies.

According to the method, there is no need to remove the material or the work remaining in the dies. That is, there is no need to operate the press machine in order to remove the material or the work remaining in the dies. Therefore, it is possible to reduce the number of operations of the press machine. As a result, the number of replacement steps of the dies can be reduced.

### BRIEF DESCRIPTION OF THE DRAWINGS

FIG. 1 is an overall view illustrating a construction of a vertical three-tiered press machine according to an embodiment of the present invention.

FIG. 2 is a plan view of FIG. 1.

FIG. 3 is a set of schematic views illustrating a method of replacing a die group of the vertical three-tiered press machine of FIG. 1.

### MODE FOR CARRYING OUT THE INVENTION

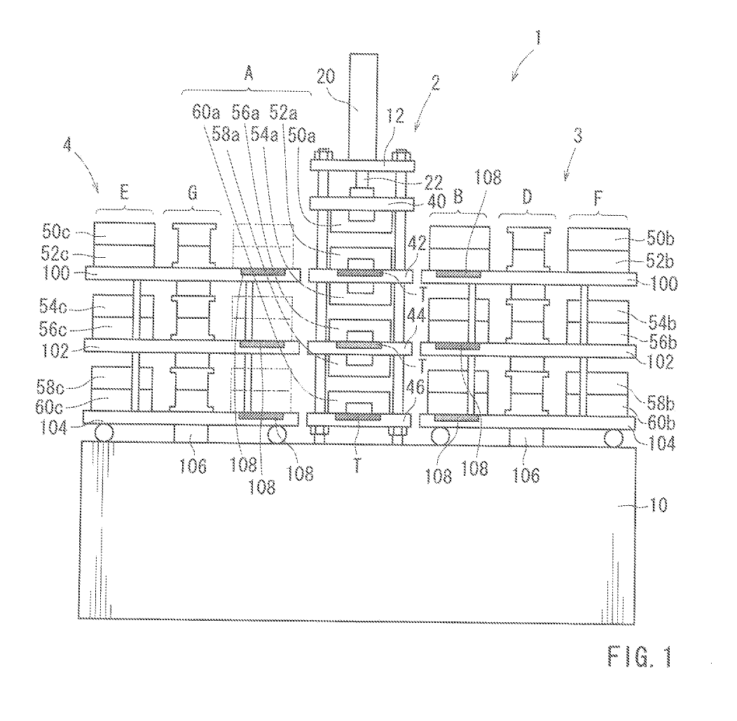

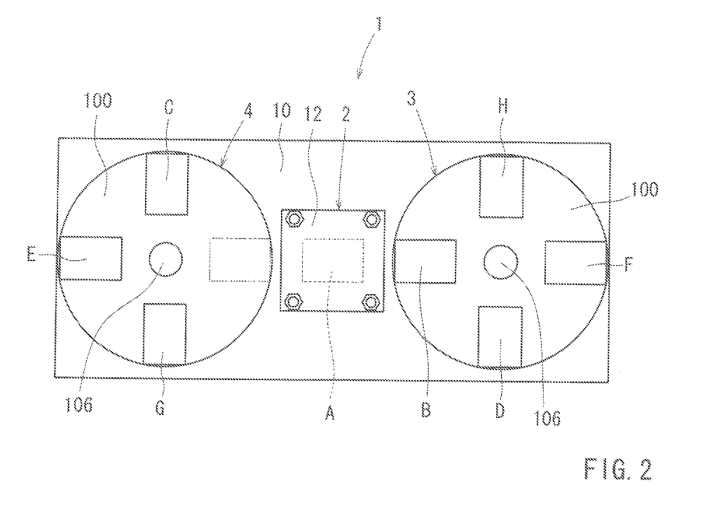

In the following, a mode for carrying out the present invention will be described with reference to FIGS. 1 to 3. First, an overall construction of a press forming system 1 according to an embodiment of the present invention will be described. As shown in FIGS. 1 and 2, the press forming system 1 is composed of a vertical three-tiered press machine 2, a first revolver 3 and a second revolver 4. In the following, the vertical three-tiered press machine 2, the first revolver 3 and the second revolver 4 will be described individually.

First, the vertical three-tiered press machine 2 will be described. Since the vertical three-tiered press machine 2 is a well-known press machine. Therefore, only a brief description thereof will be given in the description below. The vertical three-tiered press machine 2 is a press machine in which three pairs of oppositely positioned dies 50a, 52a, 54a, 56a, 58a and 60a are sequentially die-closed so as to apply pressure on the three pairs of dies 50a, 52a, 54a, 56a, 58a and 60a (a first upper die 50a, a first lower die 52a, a second upper die 54a, a second lower die 56a, a third upper die 58a and a third lower die 60a), so that a work can be formed form a material M via three steps.

The three steps consist of a first step of forming the material M into a first half processed material M1 via press working by the third upper die 58a and the third lower die 60a, a second step of forming the first half processed material M1 into a second half processed material M2 via press working by the second upper die 54a and the fourth lower die 60a, and a third step of forming the second half processed material M2 into the work via press working by the first upper die 50a and the first lower die 52a.

Thus, in the vertical three-tiered press machine 2, when a press cylinder 20 thereof is activated (when a cylinder rod 22 is extended), a driving die plate 40, a first driven die plate 42 and a second driven die plate 44 can be lowered toward a lower frame 10, so that die-closing and pressure application (which will be hereinafter simply referred to as “press working”) to the above-mentioned three pairs of dies 50a, 52a, 54a, 56a, 58a and 60a can be performed.

In the vertical three-tiered press machine 2, when the press cylinder 20 is activated inversely with the above (when the cylinder rod 22 is contracted) after the press working is performed, the driving die plate 40, the first driven die plate 42 and the second driven die plate 44 can be lifted up toward the upper frame 12, so that die-opening of the above-mentioned three pairs of dies 50a, 52a, 54a, 56a, 58a and 60a can be performed.

When the press working and the die-opening are intended to be repeatedly performed, the first half processed material M1 formed in the first step (the press working by the third upper die 58a and the third lower die 60a) is set for the second step (the press working by the second upper mold 54a and the second lower mold 56a). Subsequently, the half processed material M2 formed in the second step is set for the third step (the press working by the first upper die 50a and the first lower die 52a). The work formed in the third step is then ejected. Such setting and ejection is repeated. Thus, the work can be formed each cycle of the press working and the die-opening. Setting operations are performed by an arm (not shown) that is positioned adjacent to the vertical three-tiered press machine 2.

Further, the first driven die plate 42, the second driven die plate 44 and the stationary die plate 46 respectively clamping the lower dies 52a, 56a and 60a thereon are respectively provided with conveying mechanisms T that are capable of conveying (transferring) the lower dies 52a, 56a and 60a from themselves toward the two revolvers 3 and 4 which will be hereinafter described. For convenience in explanation, the three pairs of dies 50a, 52a, 54a, 56a, 58a and 60a will be referred to as a die group A. The vertical three-tiered press machine 2 is constructed as described above.

Next, the first revolver 3 will be described. The first revolver 3 is a storage device for stocking (storing) replacement dies of the above-mentioned die group A (the dies 50a, 52a, 54a, 56a, 58a and 60a). In this embodiment, it is constructed such that four sets of replacement dies (die groups B, D, F and H) can be stocked.

The first revolver 3 is composed of three discs 100, 102 and 104 that are positioned at predetermined intervals, and a rotation shaft 106 that is positioned in centers of the three discs 100, 102 and 104 and is integrally connected thereto.

The predetermined intervals in the three discs 100, 102 and 104 may be set such that the three discs 100, 102 and 104 can respectively be positioned at the same height as the first driven die plate 42, the second driven die plate 44 and the stationary die late 46, so that the stocked die groups B, D, F and H which will be hereinafter described can be slidably transferred to and from the three discs 100, 102 and 104 when the die-opening of the three pairs of dies 50a, 52a, 54a, 56a, 58a and 60a of the above-described vertical three-tiered press machine 2 is performed.

A lower end of the rotation shaft 106 is rotatably attached to the lower frame 10 such that the three discs 100, 102 and 104 can be positioned on the left of press portions of the vertical three-tiered press machine 2 and positioned adjacent to the same. Further, the lower end of the rotation shaft 106 is connected to a motor (not shown) via a gear (not shown). Thus, the three discs 100, 102 and 104 can be rotated about the rotation shaft 106. Further, rotation of the discs can be stopped at a desired position by a sensor (not shown).

Further, the first revolver 3 is provided with conveying mechanisms 108. The conveying mechanisms 108 are respectively supported by the lower frame 10 (a support structure is not shown). The conveying mechanism 108 may function to transfer one of the stocked die groups B, D, F and H which will be hereinafter described to the vertical three-tiered press machine 2 when one of the stocked die groups B, D, F and H comes to a transfer position in which it can be transferred to the vertical three-tiered press machine 2 (to the first driven die plate 42, the second driven die plate 44 and the stationary die plate 46) (i.e., a position adjacent to the vertical three-tiered press machine 2).

In the three discs 100, 102 and 104, four sets of first replacement upper dies 50b and first replacement lower dies 52b corresponding to the first upper die 50a and the first lower die 52a are stocked on the first disc 100. Similar to the first disc 100, four sets of second replacement upper dies 54b and second replacement lower dies 54b corresponding to the second upper die 54a and the second lower die 56a are stocked on the second disc 102.

Further, similar to the first disc 100 and the second disc 102, four sets of third replacement upper dies 58b and third replacement lower dies 60b corresponding to the third upper die 58a and the third lower die 60a are stocked on the third disc 104. A first set of dies of the four sets of dies thus stocked corresponds to the die group B mentioned above. A second set of dies corresponds to the die group D mentioned above. A third set of dies corresponds to the die group F mentioned above. Further, a fourth set of dies corresponds to the die group H mentioned above.

As shown in FIG. 2, the die groups B, D, F and are circumferentially uniformly positioned on each of the discs 100, 102 and 104 in a counterclockwise direction. Further, the die group B is stocked in a condition in which the material M, the first half processed material M1 and the second half processed material M2 are placed on each of the dies 50b, 52b, 54b, 56b, 58b and 60b. The first revolver 3 is constructed as described above.

Finally, the second revolver 4 will be described. The second revolver 4 is also a storage device stocking (storing) replacement dies of the above-mentioned die group A (the dies 50a, 52a, 54a, 56a, 58a and 60a). In this embodiment, it is constructed such that three sets of replacement dies can be stocked. Further, the second revolver 4 is constructed in the same manner as the first revolver 3 described above. Thus, elements that are the same in the two revolvers 3 and 4 will be identified by the same reference numerals in the drawing and a detailed description of such elements may be omitted.

In the three discs 100, 102 and 104 of the second revolver 4, three sets of first replacement upper dies 50b and first replacement lower dies 52b corresponding to the first upper die 50a and the first lower die 52a are stocked on the first disc 100. Similar to the first disc 100, three sets of second replacement upper dies 54b and second replacement lower dies 54b corresponding to the second upper die 54a and the second lower die 56a are stocked on the second disc 102.

Further, similar to the first disc 100 and the second disc 102, three sets of third replacement upper dies 58b and third replacement lower dies 60b corresponding to the third upper die 58a and the third lower die 60a are stocked on the third disc 104. A first set of dies of the three sets of dies thus stocked corresponds to a die group C. A second set of dies corresponds to a die group E. Further, a third set of dies corresponds to a die group G.

As shown in FIG. 2, the die groups C, E and G are circumferentially positioned on each of the discs 100, 102 and 104 at intervals of 90 degrees in a counterclockwise direction. Further, as will be apparent from FIGS. 1 and 2, the second revolver 4 is provided with empty spaces, so that the die group A of the vertical three-tiered press machine 2 can be stocked therein. The second revolver 4 is constructed as described above.

Thus, the press forming system 1 is composed of a vertical three-tiered press machine 2, a first revolver 3 and a second revolver 4.

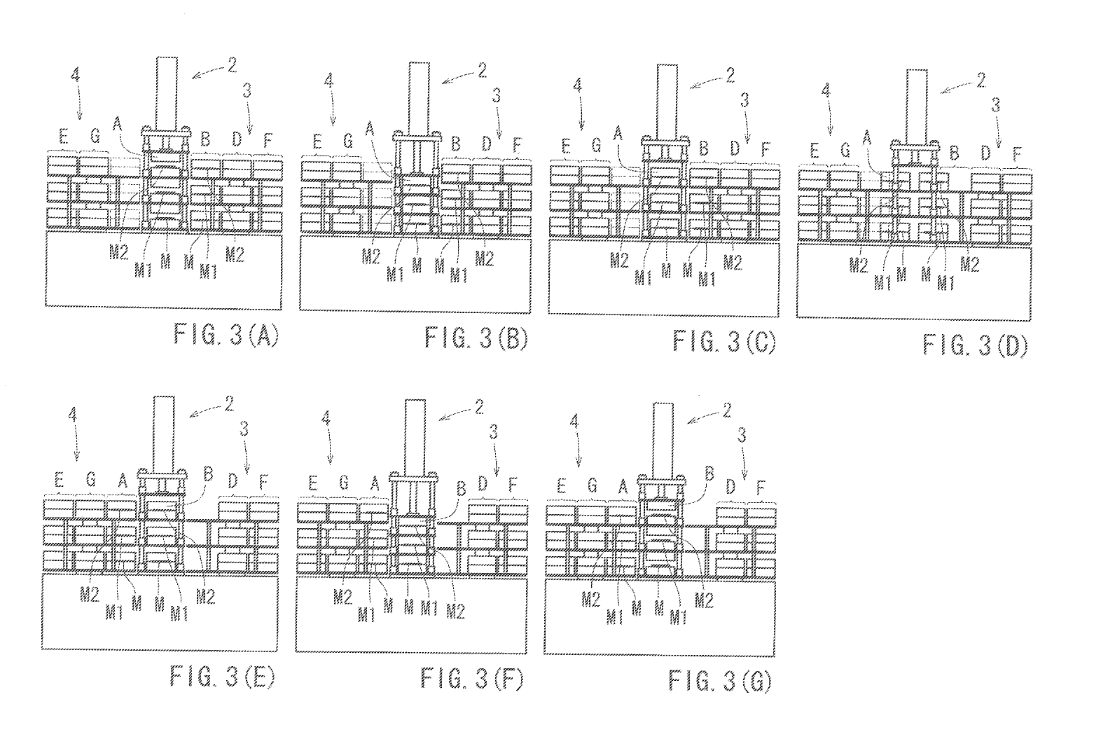

Next, a method for replacing the die group A (the three pairs of dies 50a, 52a, 54a, 56a, 58a and 60a) of the above-described vertical three-tiered press machine 2 with the die group B (the three pairs of dies 50b, 52b, 54b, 56b. 58b and 60b) of the first revolver 4 will be described with reference to FIG. 3. First, a condition in which the work is successively formed a condition in which the material M, the first half processed material M1 and the second half processed material M2 remain in the die group A, so that the press-working without materials can be avoided) will be described (FIG. 3 (A)).

First, in this condition, the die group A is die-closed. After the die-closing is completed, each of the die group A is unclamped (unlocked) (FIG. 3 (B)). Next, a die-opening operation is conducted on the die group A as die-closed (FIG. 3 (C)). Thereafter, the conveying mechanisms T of the vertical three-tiered press machine 2 and the conveying mechanisms 108 of the second revolver 4 corresponding to the empty spaces (shown by broken lines) are actuated, so as to slide the die group A to the second revolver 4.

At the same time, the conveying mechanisms 108 of the first revolver 3 corresponding to the die group B are actuated, so as to slide the die group B to the vertical three-tiered press machine 2 (FIG. 3 (D)). When sliding of the die groups A and B has been completed (FIG. 3 (E)), the die group B is die-closed. After the die-closing is completed, each of the die group B is clamped (locked) (FIG. 3 (F)). Finally, a die-opening operation is conducted on the die group B (FIG. 3 (G)).

The die group A of the vertical three-tiered press machine 2 according to the embodiment of the present invention is replaced by the method as described above. According to this method, the die group A can be replaced with the die group B in the condition in which the material M, the first half processed material M1 and the second half processed material M2 remain in the die group A. Therefore, there is no need to remove the material M, the first half processed material M1 and the second half processed material M2 remaining in the die group A. That is, there is no need to operate the press machine in order to remove the material M, the first half processed material M1 and the second half processed material M2 remaining in the die group A. Therefore, it is possible to reduce the number of operations of the press machine. As a result, the number of replacement steps of the die group A can be reduced. Further, in the die group B as replaced, the material M, the first half processed material M1 and the second half processed material M2 remain therein. Therefore, when the press machine is operated after the die group A is replaced with the die group B. the work can be immediately formed in first press working after replacement.

The embodiment described above is an example of the present invention and the present invention is not limited to the embodiment described above.

In the above-describe embodiment, “the vertical three-tiered press machine 2” is exemplified as “the press forming machine.” However, this should not be construed restrictively. That is, the number of tiers can be variously changed so long as there are a plurality of tiers.

Further, in the above-described embodiment, the first revolver 3 can stock the four sets of replacement dies. However, this should not be construed restrictively. That is, the number of sets that can be stocked can be variously changed. In such a case, the number of the conveying mechanisms 108 should be changed corresponding to the number of sets.

Further, in the above-described embodiment, the die group A of the vertical three-tiered press machine 2 is replaced with the die group B for replacement. However, this should not be construed restrictively. That is, the die group A can be replaced with any one of the replacement die groups D, F and H. In this case, the three discs 100, 102 and 104 of the first revolver 3 may be rotated until one of the groups D, F and H to be replaced reaches the transfer position of the vertical three-tiered press machine 2 (a position of the die group B in FIG. 2). This also applies to the second revolver 4.

Further, in the embodiment, the three pairs of dies 50a, 52a, 54a, 56a, 58a and 60a are replaced with others. However, this should not be construed restrictively. That is, one, two or any other number of pairs of dies can be replaced with others.

1. A die replacing method for a press forming machine in which a material inserted between at least one pair of oppositely positioned dies can be pressed by the at least one pair of dies, so that a work can be formed from the material,
wherein when the at least one pair of dies is replaced, the at least one pair of dies can be replaced while the material or the work is held between the at least one pair of dies.
